(19) United States
(12) Patent Application Publication
(10) Pub. No.: US 2009/0155471 A1
(43) Pub. Date: Jun. 18, 2009

(54) Method and Apparatus for Coating Pine Straw

(76) Inventor: Jack Mason, Beech Island, SC (US)

Correspondence Address: CALHOUN "REB" THOMAS, III, 1201 MAIN STREET, SUITE 1750, COLUMBIA, SC, 29201, US

(21) Appl. No.: 12/391,692

(22) Filed: Feb. 24, 2009

Related U.S. Application Data
(63) Continuation-in-part of application No. 11/454,917, filed on Jun. 16, 2006.
(60) Provisional application No. 61/038,189, filed on Mar. 20, 2008.
(60) Provisional application No. 61/043,181, filed on Apr. 8, 2008.

(51) Int. Cl. B05D 3/12; B05C 5/00

(52) U.S. Cl. 427/372.2; 118/300

(57) ABSTRACT

The invention is an apparatus and method for coating straw with fertilizers, preservatives and/or colorants to extend the useful life of and add aesthetic properties to pine straw. The invention comprises the steps of providing a drying chamber, collecting straw, placing the straw into windrows within the drying chamber, providing a means for simultaneously fluffing and coating the straw, fluffing and coating the, and then drying the straw inside the drying chamber until the coating is dry. The means for simultaneously fluffing and coating the straw is an apparatus that features a fluffing system, a coating system, and an application chamber all of which may be powered and operated via a standard farm tractor with hydraulic ports and power take-off connections. The apparatus is designed to fluff the straw within an application chamber wherein the coating is simultaneously applied to the tossed and, thereby, temporarily suspended pine straw.

### RELATED APPLICATIONS

This application is a continuation-in-part of and claims the benefit of prior filed, co-pending U.S. non-provisional application Ser. No. 11/454,917 filed Jun. 6, 2006. This application also claims the benefit of prior filed, co-pending U.S. provisional application 61/038,189 filed Mar. 20, 2008. This application also claims the benefit of prior filed, co-pending U.S. provisional application 61/043,181 filed on Apr. 8, 2008.

### FEDERALLY SPONSORED RESEARCH OR DEVELOPMENT

Not applicable

### REFERENCED OR INCORPORATED MATERIAL

U.S. non-provisional application Ser. No. 11/454,917, U.S. provisional application 61/038,189, and U.S. provisional application 60/043,181 are herein incorporated by reference in their entireties.

### BACKGROUND OF INVENTION

Pine straw has long been used as a ground cover and mulch in landscaping settings. Traditionally pine straw is first collected in forests comprised predominately of pine trees. Once collected, the pine straw is then transported to a given landscape. Once delivered to the landscape, the pine straw is distributed and placed around trees, shrubbery, flowers, other plants, and other landscape fixtures such as statues, fountains, ponds, and sidewalks.

The distribution of pine straw in landscape serves many purposes. It is often used for aesthetic purposes but also for mulching, plant protection, vegetation control, erosion control, and many other uses.

Pine straw has a limited life once distributed in a landscape. While initially it has a uniform color and texture, as it is exposed to the elements, it quickly begins to age. It fades when exposed to UV light and also has a tendency to quickly mold in moist environments and to decay. As a result, the old pine straw must be frequently replenished with freshly collected pine straw.

### SUMMARY OF THE INVENTION

The present invention is a method and an apparatus for coating straw, particularly pine straw, with one or more of fertilizers, preservatives, and colorants to add additional aesthetic properties to and to effectively extend the useful life of collected pine straw. (As used hereinafter, the word “coating” shall comprise fertilizers, preservatives and/or colorants.) The present invention allows the pine straw to be colored with a coating, that is biodegradable in alternate embodiments, in a way that maximizes surface area application while minimizing excess coating waste and minimizing drying time. Though “pine straw” is the variant most often referenced herein, it is to be understood that the invention is designed to coat many different types of “straw” including wheat straw, hay, and other such plant and artificial products.

The process begins with the straw being collected. Depending on the type of straw, the collection method and collection location will vary considerable. Some pine straws collected in forests may be collected by machine while other pine straws may require only manual collection. Likewise some straw, such as wheat straw, may be collected in fields by machine.

Once collected the straw may optionally be chopped into smaller pieces prior to being coated. For either chopped straw or natural straw, the straw must then be placed into windrows within a drying chamber. This drying chamber is provided prior to the placement and is preferably a greenhouse such as those found in the art of agriculture. This greenhouse, serving as a drying chamber, will have a transparent or translucent insulated shell made of material such as glass or plastic that allows the suns rays to warm the chamber. It will have a means for controlling the humidity so that the air within the chamber remains relatively dry. Also, in the preferred embodiment, the drying chamber provided should be long and have the ability to enclose multiple windrows as well as the fluffing and coating means. Alternate embodiments may include drying chambers that include drying means other than via greenhouses.

With respect to the fluffing means, the key features of the fluffing/coating apparatus include mechanisms facilitating the fluffing of the pine straw as the coating is applied. To accomplish these features, the fluffing means utilizes a fluffing system, a coating system, and an application chamber. The key is that the straw must be suspended momentarily in the air. This suspension can be achieved via rolling/tumbling as described in one embodiment disclosed in the parent Ser. No. 11/454,917 application or via the tossing/tumbling/fluffing more fully described in the present preferred embodiment.

In either case, respecting the heart of the invention, the fluffing system effectively tosses the straw, momentarily suspending it in air. The coating system generally stores the coating material (typically a liquid) and then distributes it evenly onto the pine straw which has been momentarily suspended in the air. The application camber provides a confinement zone, for both the momentarily suspended pine straw and the coating, inside which the coating and the pine straw mix, come in contact with each other, and begin the bonding and drying process. The application chamber has top and side walls off of which the tossed pine straw bounces as it is being fluffed and coated.

In order to accomplish this fluffing, the apparatus utilizes a rapidly rotating fluffing means as part of the fluffing system. The fluffing means contacts a pile of straw and tosses it into the air within the confines of the application chamber. While in the air, the individual needles of the straw are spatially displaced from one another.

In order to accomplish the above referenced coating, the apparatus utilizes a series of nozzles or distribution points as part of the coating system. These nozzles are placed around the inner surfaces of the application chamber and are pointed inward so that the coating spray is directed toward the spatially displaced needles of straw. As the coating is discharged via the nozzles, the needles of the straw are each covered with the applied coating.

An additional feature of the invention allows the device to process large volumes of straw at a time. This feature is accomplished via a motivator means. This motivator means allows the apparatus's fluffing and coating features to be applied to large quantities of straw over a short period of time. While the motivator means could be any such means readily recognized by those skilled in the art to accomplish this task such as a conveyor belt, as will be discussed further below, the preferred embodiment contemplates the use of a standard farm tractor to move the apparatus across long rows of piled, uncoated straw.

After the straw is placed inside the drying chamber the provided fluffing and coating means is utilized to fluff and coat the straw with the fertilizers, preservatives and/or colorant. As used herein, the term “to fluff” or “fluffing” relates to the physical tossing of the straw into the air by the fluffing and coating apparatus. Following the coating, the straw remains in the drying chamber until it has dried to a sufficient condition for packaging and transport to market.

The process may be repeated as additional coatings are desired or required.

### BRIEF DESCRIPTION OF THE SEVERAL VIEWS OF THE DRAWINGS

FIG. 1 is a side view of the invention.

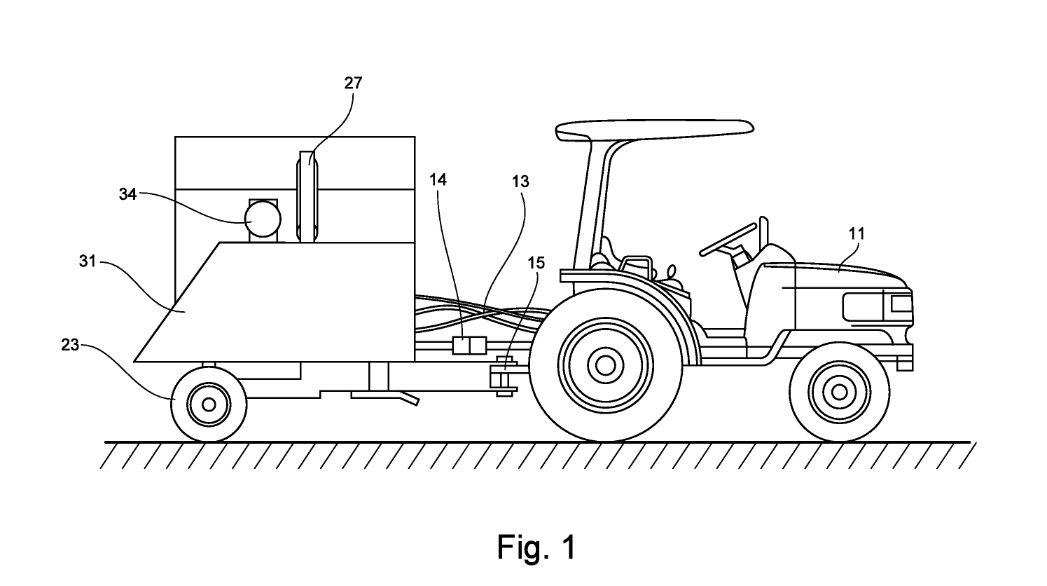

FIG. 2 is a rear view of the invention with the hood portion of the apparatus frame raised over straw.

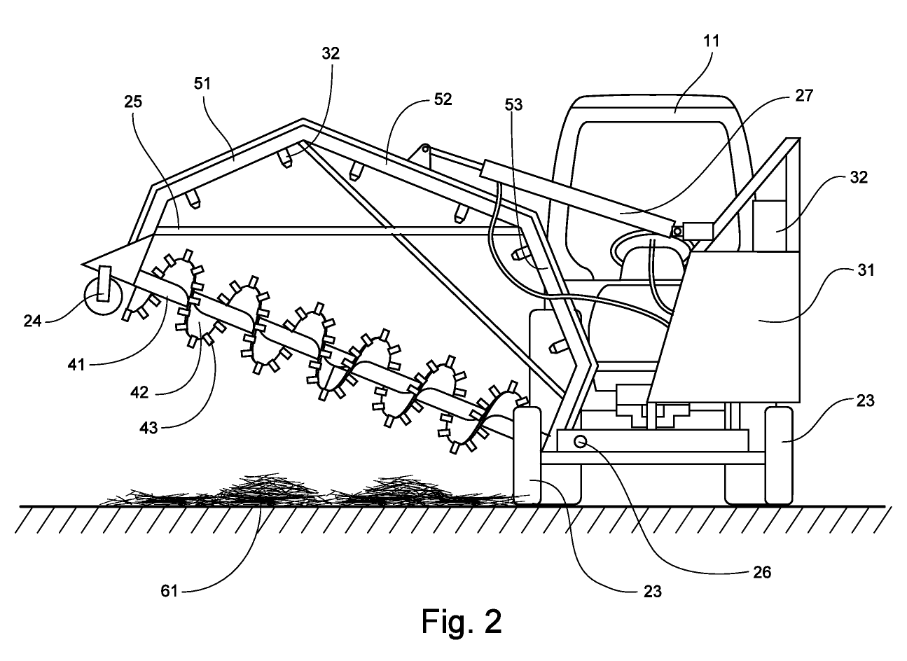

FIG. 3 is a rear view of the invention with the hood portion of the apparatus frame lowered over straw in preparation for fluffing.

FIG. 4 is a front view of the invention with the hood portion of the apparatus frame lowered over straw in preparation for fluffing.

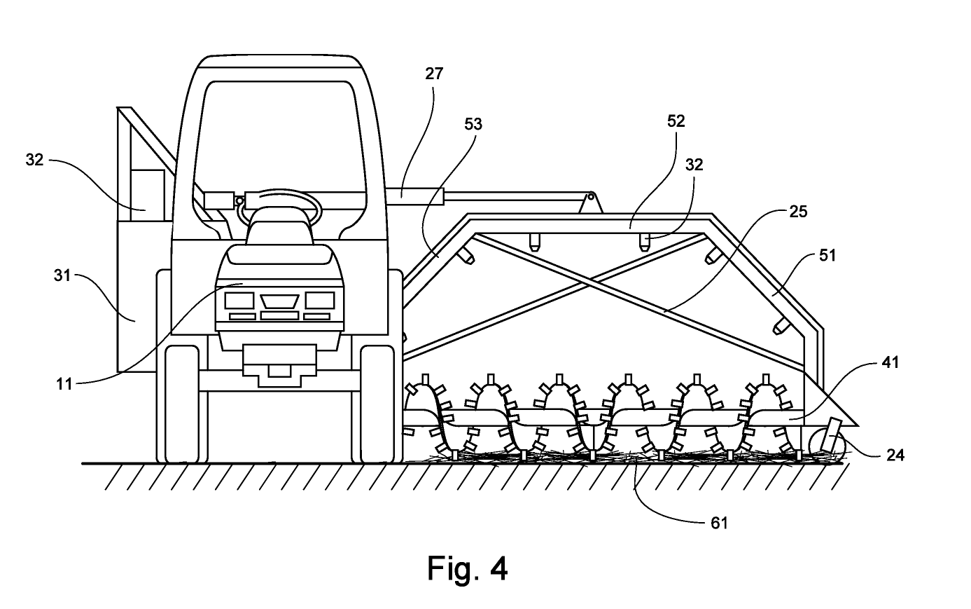

FIG. 5 is a rear view of the invention with the hood portion of the apparatus frame lowered over the straw and highlighting the straw being fluffed.

FIG. 6 is a rear view of the invention with the hood portion of the apparatus frame lowered over the straw and highlighting the straw being fluffed and coated.

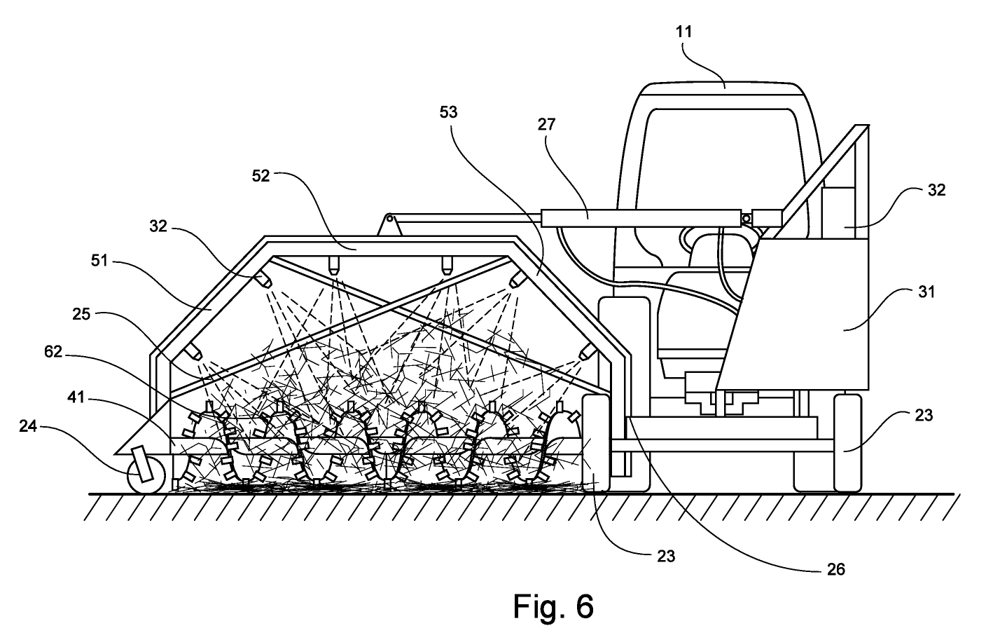

FIG. 7 is a side view of the invention with a cut away highlighting the fluffing means.

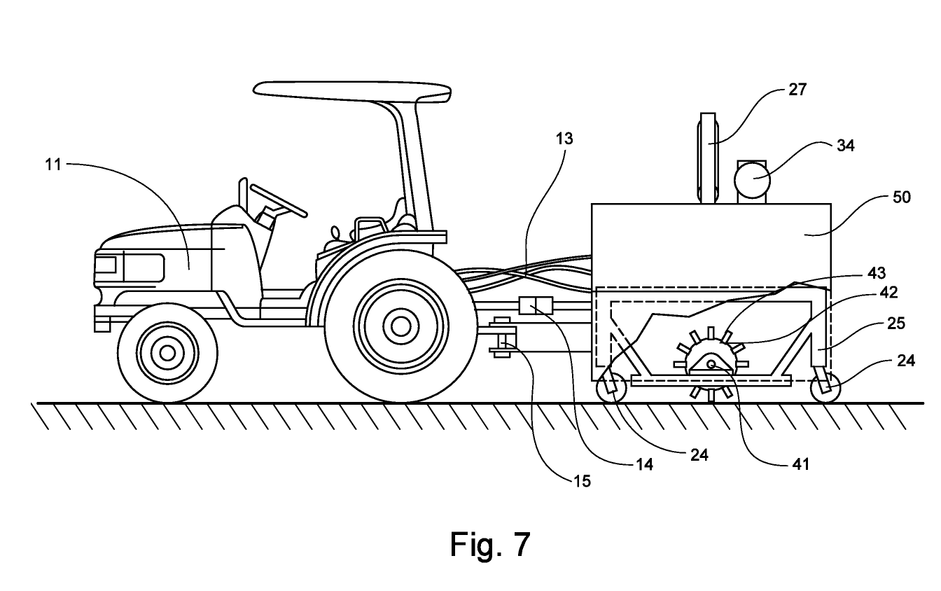

FIG. 8 is a top view of the invention.

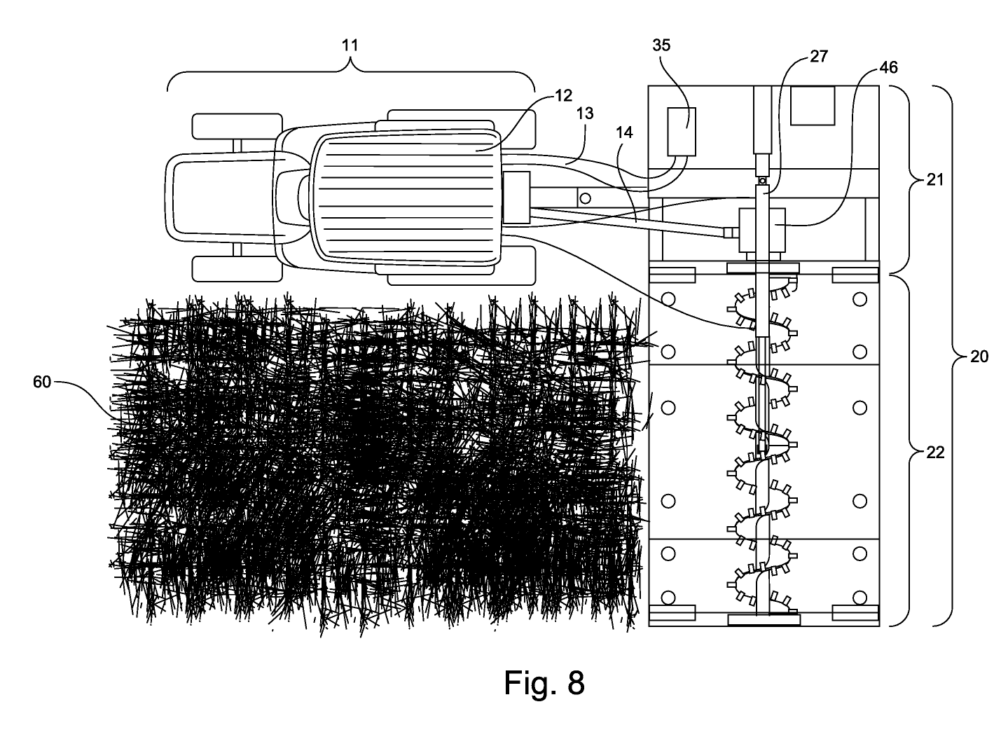

FIG. 9 is a perspective view a portion of the fluffing means, highlighting the fluffing shaft (41), the fluffing paddles (42), the fluffing arms (43), the fluffing tips (44), and the fluffing tip connection bolts (45).

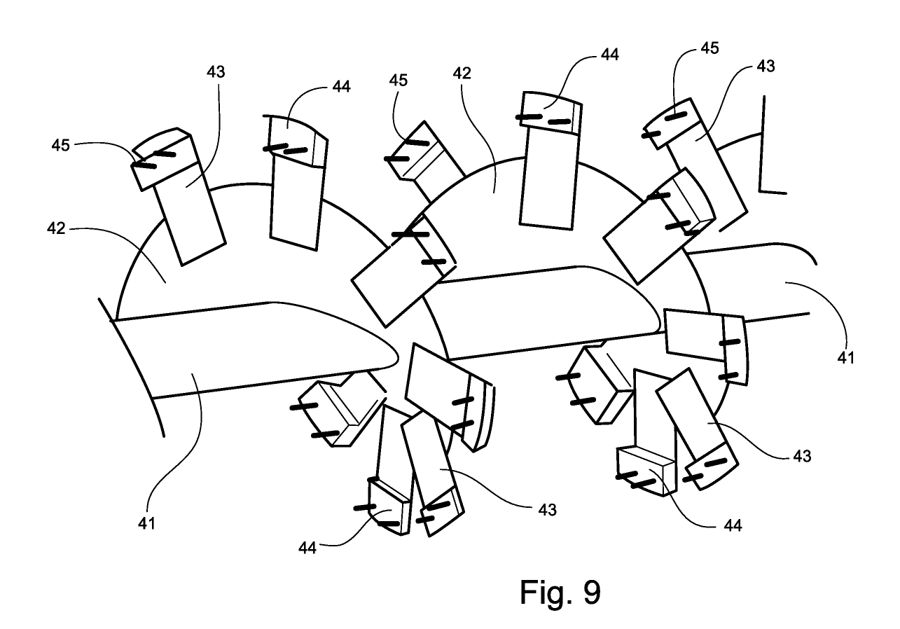

FIG. 10 is a flow diagram of the method.

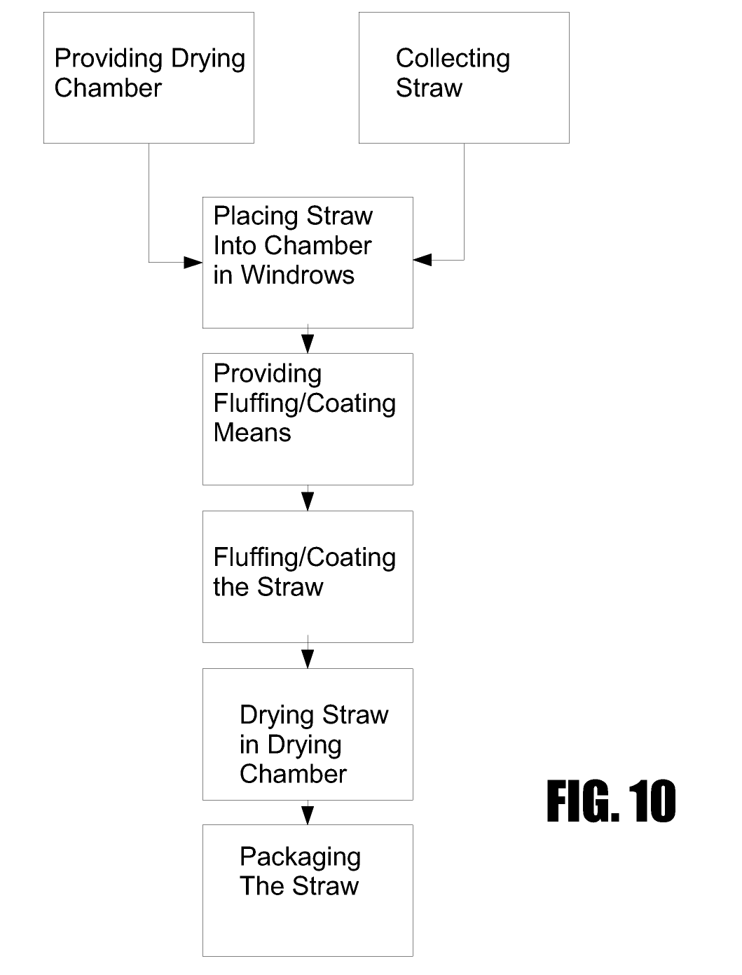

FIG. 11 is a flow diagram of the method that takes into account alternate embodiments.

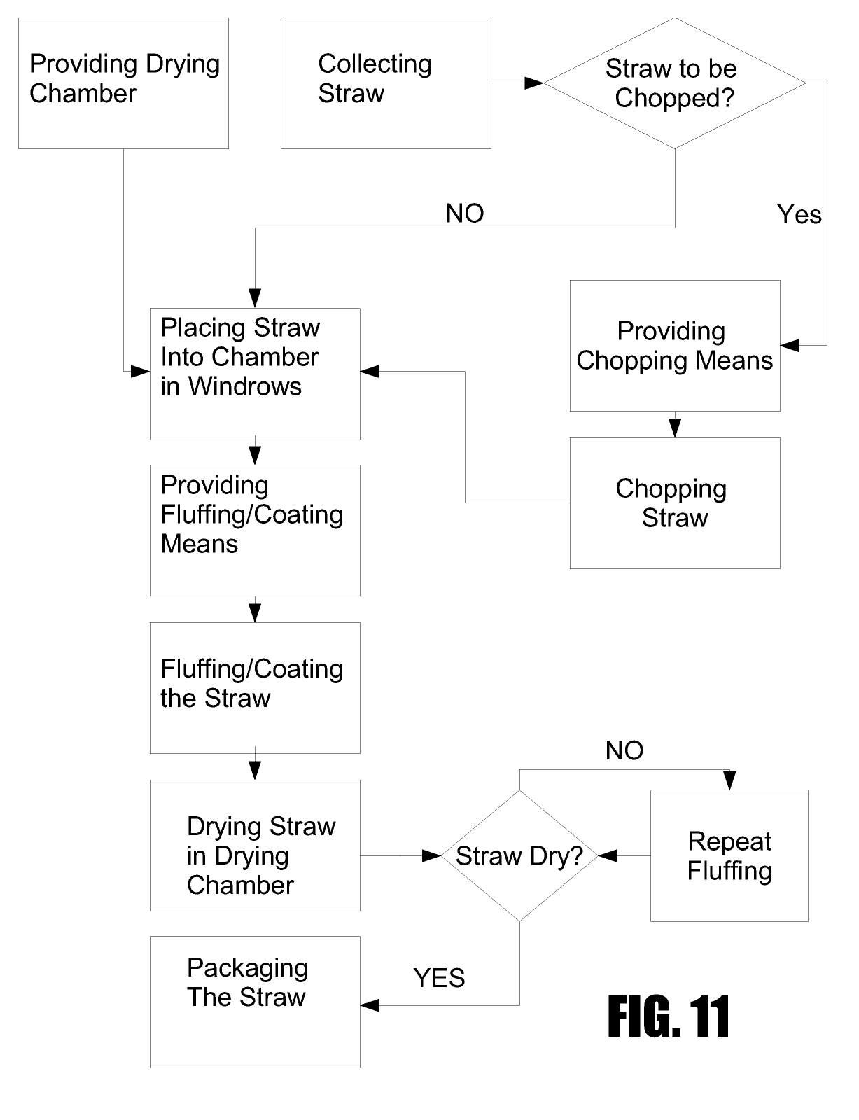

FIG. 12 is a perspective view of the options of the present invention.

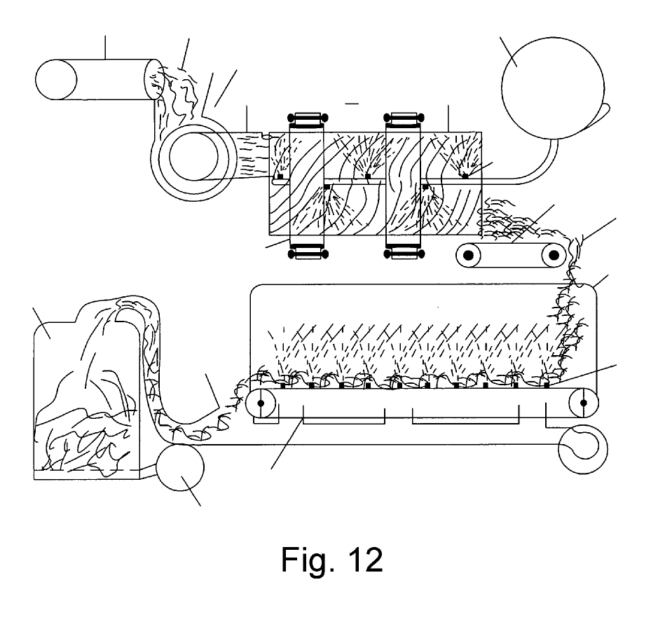

FIG. 13 is a view of the hopper and sorting options of the invention.

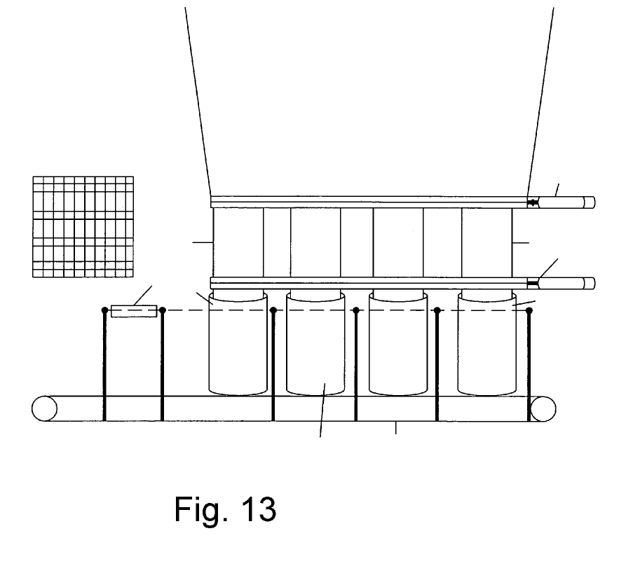

### DETAILED DESCRIPTION

It is to be understood by a person having ordinary skill in the art that the present discussion is a description of exemplary embodiments only, and is not intended as limiting the broader aspects of the present invention. The following example is provided to further illustrate the invention and is not to be construed to unduly limit the scope of the invention.

The invention includes the basic steps of providing a drying chamber, collecting straw, placing the straw into windrows within the drying chamber, providing a means for simultaneously fluffing and coating the straw, fluffing and coating the straw by applying the means for fluffing and coating the straw, and then drying the straw inside the drying chamber provided in the first step until the coating is dry. As relayed in the drawings, the steps of providing the drying chamber and of collecting the straw come early in the process and necessarily before the step of placing the straw into windrows. Likewise the step of applying the means for fluffing and coating the straw necessarily comes after the means of fluffing and coating the straw has been provided and after the straw has been placed into windrows. Further, where necessary in alternate embodiments to accelerate drying times, an additional step of fluffing the coated straw is inserted as a sub-step of the drying the straw in the drying chamber.

Additionally, where desirable in alternate embodiments of the process, a step of chopping the straw is inserted prior to the straw being placed in the windrows. In still a further alternate embodiment, a final step of packaging the straw is included by bagging or bailing means.

As mentioned above, one early step is providing a drying chamber. In the present embodiment, this drying chamber may comprise any large facility capable of enclosing long windrows of straw and of reducing moisture content in the air. Indeed, somewhat counter-intuitively, the “drying chamber” itself may even comprise an open air situation such as a field where the sun's rays naturally dry the straw without the need for any physical structure. Preferably, the drying chamber reduces the air humidity to a low moisture content and will allow for at least two windrows of straw. This chamber will also afford necessary room for the simultaneous fluffing and coating meanings to maneuver within the chamber. The drying chamber may utilize such drying elements as electric or gas heating or dehumidifying. Preferably, the drying chamber is a greenhouse utilizing solar heating, located in an area of full sun exposure, having insulated transparent surfaces made of such materials as glass or plastic, and having humidistatically operated ventilation windows that open and pull humidity out of the chamber until the humidity reaches a low threshold such as below 30-35 percent humidity. The chamber allows for fluffing/tumbling to take place within which aids in the drying process.

A second early step comprises collecting the straw. This straw may be collected in natural forests, planned/planted tree farms, in fields, in aquatic environments, or in synthetic environments. The straw may be collected either mechanically or manually.

The next step involves placing the straw into windrows inside the drying chamber provided in the first step. Utilizing the preferred embodiment of the drying chamber, there will be two linear windrows running the length of the drying chamber.

In one embodiment, the next step comprises providing a means for simultaneously fluffing and coating the straw. This means is able to move down the windrows fluffing and spray coating the straw with the supplied coating as it moves. That is, the straw will be tossed and displaced in the air as it is sprayed with the coating and then allowed to fall back into the windrow. Preferably, this means is the fluffing and coating apparatus that is discussed further below.

After the means for simultaneously fluffing and coating the pine straw has been provided and the straw is initially positioned in windrows, the next step is to actually fluff and coat the straw by applying the aforementioned means of fluffing and coating the straw. In this step, the means for coating and fluffing the straw will move over the windrows in linear fashion, rapidly tossing and spray coating the straw with fertilizer, preservatives, and/or colorant. The straw will then fall back to the bottom surface of the drying chamber in roughly the same area as the original in the windrows.

The next step, after the straw has been coated, is drying the straw within the drying chamber. In the preferred embodiment, the drying chamber has already been provided, the straw has already been positioned into windrows within the drying chamber, and the straw has been coated. This drying step, then, is applied to reduce moisture and allow the coating to dry onto the straw needles. With the humidistatically operated ventilation system operating, the fans and/or vent windows will vent the humidity from the drying chamber and heat will be generated within the greenhouse from the solar rays. In a short time, the fluffed and coated straw will dry. In alternate embodiments, it may be necessary to run the fluffing apparatus with the spray function turned off additional times once the straw has been coated so that it can dry more efficiently.

Within the drying step outlined above, an additional sub-step is included in alternate embodiments. In this sub-step, the fluffing and coating means provided above is again utilized and applied to the windrows for purposes of fluffing only. That is, the coating function of the fluffing and coating means is turned off and the only fluffing functions are applied to the already coated straw. This sub-step may be repeated as necessary to effectively dry the straw. This step may be also utilized with the spray turned on and another type of coating applied. For instance, if colorant were applied first, fertilizer may be applied in a second coating.

In an alternate embodiment another step exists, following the drying step, which comprises the step of packaging the straw. In this step the straw may be packaged into bags or bailed into bails. In one embodiment, the straw next is placed into an initial storage bin situated above a plurality of hoppers. A hydraulic cylinder opens and closes the storage bin to permit the colored pin straw to drop into hoppers. The hoppers may comprise a plurality of sizes and hold between 2-5 square feet of straw or more depending on alternate embodiments. A second hydraulic cylinder opens and closes to permit the hoppers to empty into containers. The containers then proceed by a conveyor to a sealing unit that seals the containers.

In another alternate embodiment, another step exists, that can occur either simultaneous to or following the straw collection step that comprises first providing a means of chopping the straw into smaller pieces and then of applying said means of chopping the straw into smaller pieces such that the resulting needles of straw are much smaller. In these embodiments, a chopper must first be provided. Preferably, this chopper is a hammer mill having a plurality of cutting sheers to control the size of the cut needles.

The means for simultaneously fluffing and coating the straw comprises three subsystems, namely, a fluffing system, a coating system, and an application chamber. The invention also comprises a motivator means. In the preferred embodiment, this motivator means is supplied via a tractor (11) that pulls the apparatus along rows of piled straw such as windrows (61). The tractor also supplies the rotational power for the fluffing system via the power take-off (14) and hydraulic power for the coating system via the hydraulic output (12) of the tractor. All of these subsystems are tied together via the apparatus frame (20).

The fluffing system utilizes a fluffing means and in this embodiment comprises a fluffing shaft (41), fluffing paddles (42), fluffing arms (43), fluffing tips (44), and fluffing tip connection bolts (45). As noted above, the power for the fluffing system is supplied by the tractor's (11) power take-off (14). The fluffing shaft (41) is removably connected to the power take-off (14) of the tractor. In one embodiment the power take-off (14) is connected to the fluffing shaft (41) via a 90 degree gear head (46). Thus, the fluffing shaft (41) runs perpendicular to the tractor (11) and to the windrows of pine straw (61). In the preferred embodiment, the fluffing shaft (41) is made of metal and rotates at a rate of speed necessary to ensure that the straw is rapidly and forcefully projected into the air (62) inside the application chamber (50). In the present embodiment, the tractor's power take-off (14) operates at 540 rpm and a gear ratio to the fluffing shaft (41) of roughly 1:1.4 provides sufficient projection for the typical pine straw. Of course different power take-off revolution rates and gear ratios can also be used to achieve the necessary fluffing (62).

Fixedly attached to the fluffing shaft (41) is a plurality of spiral fluffing paddles (42). These spiral fluffing paddles (42) are also made of metal. In the present embodiment, these fluffing paddles (42) are fixed in two opposed sets with the paddles spiraling toward the midpoint of the fluffing shaft (41). Each set of fluffing paddles (42) is of equal length and is the reciprocal of the opposed set. Each set of fluffing paddles (42) begins on the outer edges of the fluffing shaft (41) and spirals toward the midpoint.

Fixedly attached to the fluffing paddles (42) is a plurality of fluffing arms (43). These fluffing arms (43) are also made of metal. The fluffing arms (43) radiate outward from the fluffing paddles (42) in the direction away from the fluffing shaft (41).

Removably attached to each of the fluffing arms (43) are fluffing tips (44). The fluffing tips (44) are made of a softer material than the fluffing arms (43) such as rubber. The fluffing tips (44) are attached to the fluffing arms (44) via a bolt attachment means. These bolts, the fluffing tip connection bolts (45), extend and project beyond the surface of the fluffing tips (44) in the present embodiment though such projection is not required.

The fluffing shaft (41) is also attached to the apparatus frame (20). This attachment allows the fluffing shaft (41) to rotate about its axis while being fixed in the perpendicular direction. The apparatus frame (20) further comprises two portions, the trailer portion (21) and the hood portion (22). The trailer portion (21) can be removably attached to the tractor (11) via the tractor's hitch connection (15). The trailer portion (22) has a plurality of wheels (23) and a rigid frame for supporting portions of the coating system. This trailer portion (21) is made of metal of requisite strength to support the coating system and the attached hood portion (22).

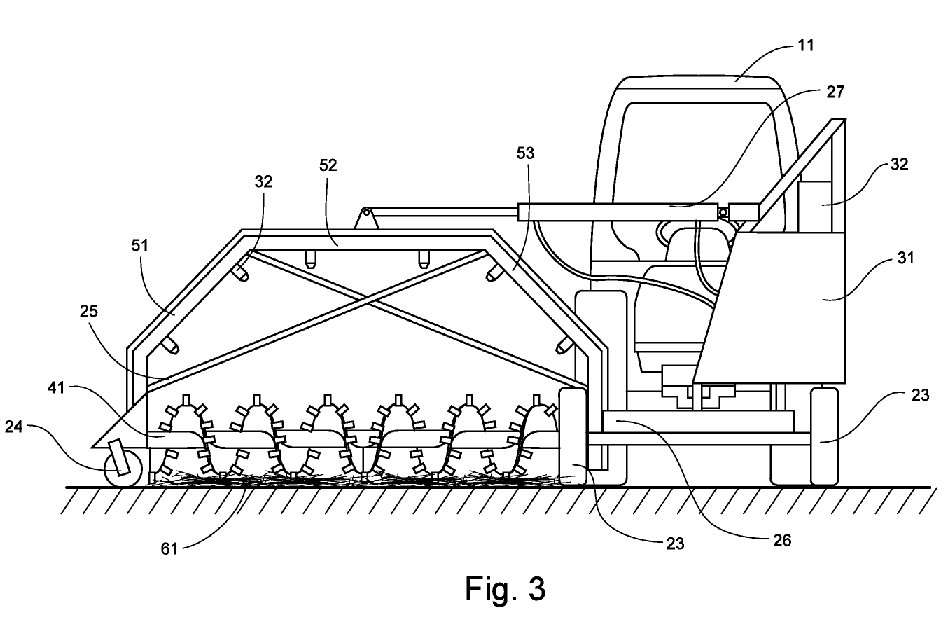

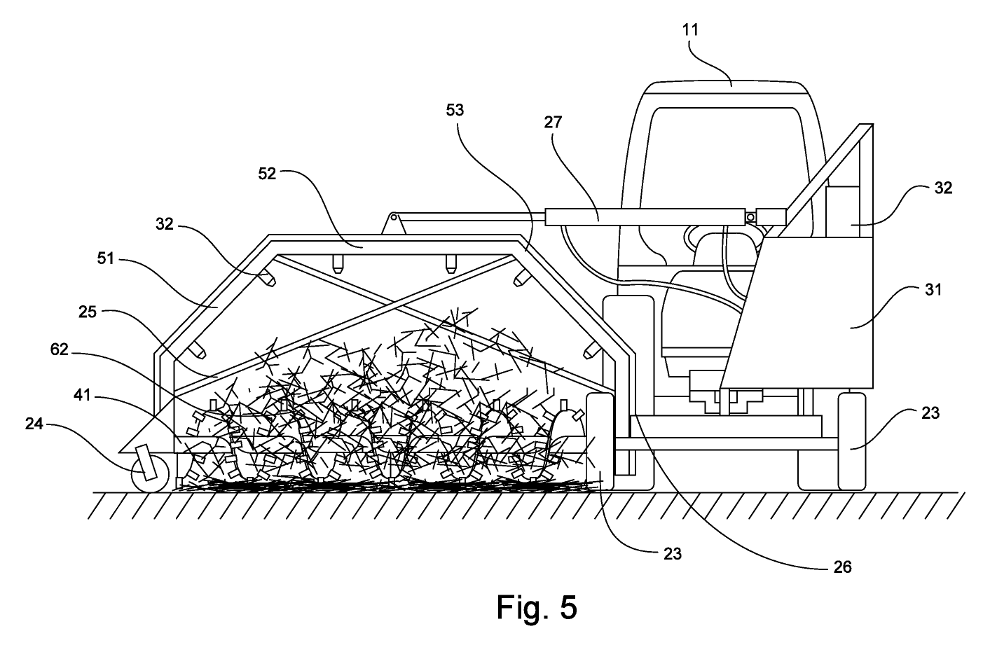

The hood portion (22) is hingedly (26) and hydraulically (27) attached to the trailer portion (21) and houses the fluffing system and the application chamber. The hydraulic attachment point is a hydraulic cylinder (27) designed to lift the hood portion (22) while traveling. The hydraulics for this hydraulic cylinder (27) is supplied via the hydraulic connections (12) from the tractor and are carried via hydraulic lines (13). The hood portion (22) also has a wheel (24), or a plurality of wheels (24) in alternate embodiments, that touches the ground when the hood portion (22) is lowered for use in fluffing (as shown in FIG. 3) and coating (as shown in FIG. 5) which is also known as the engaged position. The hood portion (22), like the trailer portion (21), is also predominately made of metal and has sufficient cross bracing (25) to aid in the support the fluffing shaft (41) and the application chamber, although alternate embodiments of plastic or other materials are clearly contemplated. The hood portion (22) serves as the upper and side boundaries of the application chamber.

The coating system comprises a large spray tank (31) for containing the coating, a plurality of spray nozzles (32), a plurality of transport lines for delivering the coating to the spray nozzles (33), a hydraulic pump (34) for distributing the coating through the transport lines (34) to the spray nozzles (33), and a control means (35) for controlling the flow of the coating. Additional embodiments include an air operated circulating pump for mixing the coating in the tank.

The spray tank (31) is fixedly attached to the trailer portion (22) of the apparatus frame (20). For embodiments that include the mixing pump, a standard air operated circulating pump is fixed inside the tank (31) to mix the coating materials contained within the tank (31). This air operated mixing pump is preferably powered by an external air compressor supplying compressed air to the pump. This air operated mixing pump mixes the coating inside the tank prior to the start of the coating process.

The hydraulic pump (34) pumps the coating from the tank (31) through the transport lines (33). The control means (35) is any device that can regulate the operation of the pump (34) and the flow of the coating through the transport lines. The transport lines run from the outflow of the hydraulic pump to spray nozzles (32) positioned on the inside of the hood portion (22) of the apparatus frame (20), that forms the inside surface of the application chamber, above the fluffing shaft (41).

The application chamber, and its constituent parts, is fixedly attached to the hood portion (22) of the apparatus frame (20). The application chamber provides top and side surfaces to contain the straw that is being fluffed and coated. Specifically in this embodiment, the application chamber has a far side wall (51), a top wall (52), and a near side wall (53). The far side wall (51) is that side furthest away from the spray tank (31) and the near side wall (53) is that side nearest the spray tank (31). The top wall (52) is that wall directly above and parallel to the fluffing shaft (41). Each of these walls has both an inner and an outer surface. The inner surface is that surface with which some of the straw (62) comes into contact while being fluffed. The transport lines and spray nozzles (32) of the coating system are attached to the hood portion (22) of the apparatus frame (20) just beneath these near (53), top (52), and far (51) walls of the application chamber. The walls of the application chamber (51, 52, & 53) may be made of any lightweight material such as aluminum, plastic, or fiberglass.

Though less preferred, another embodiment for fluffing and drying incorporates a series of conveyor belts and forced air. This embodiment incorporates an input conveyer to input a quantity of pine straw. The pine straw is then fed to the chopping mill via a first conveyor such as the hammer mill discussed above. A second conveyor then moves the now chopped pine straw to a spray coating unit. This spray coating unit comprises a rotating bin which is powered by a rotating mechanism. A spray colorant is then fed by high pressure nozzles from a tank into the bin and onto the needles. The rolling spray unit fully covers the chopped pine straw with coloring agent. A third conveyor then takes the colored straw and moves it into a high pressure air drying unit. The dryer unit comprises a container. High pressure heated air, fed from the bottom of the dryer dries the pine straw which is moved by a fourth conveyor toward a blower. The blower blows the dried, coated straw into a storage bin as disclosed above.

I claim:

1. A method of coating straw comprising the steps of:
Step 1) collecting a quantity of straw;
Step 2) providing a hopper which feeds a hammer mill for chopping straw; providing a means for momentarily suspending and coating the straw; and providing a means for drying the straw;
Step 3) placing the quantity of straw into the hopper and chopping the straw;
Step 4) applying the means for momentarily suspending and coating the straw, thus coating the straw;
Step 5) drying the straw using the means for drying the straw provided in step 2, and providing a packaging system; and
Step 6) placing the pine straw into the packaging system and packaging the straw.

2. The method of coating straw of claim 1 wherein the means for drying the straw is a greenhouse with a humidistatically operated ventilation system that that opens and pulls moisture out of the greenhouse until the humidity reaches a preset threshold.

3. The method of coating straw of claim 2 wherein the means the means for momentarily suspending and coating the straw is a fluffing and coating apparatus that performs the sub-steps of
Step 4A) contacting the straw with a plurality of rapidly rotating fluffing arms;
Step 4B) tossing the straw into the air; and
Step 4C) applying a coating to the straw while the straw is in the air.

4. A method of coating straw comprising the steps of:
Step 1) providing a drying chamber;
Step 2) collecting straw;
Step 3) placing the straw into a windrow within the drying chamber;
Step 4) first, providing a means for simultaneously fluffing and coating the straw and, second, fluffing and coating the straw; and
Step 5) drying the coated straw within the drying chamber;

5. The method of coating straw of claim 4 wherein the means the means for simultaneously fluffing and coating the straw is a fluffing and coating apparatus that comprises a tractor motivator means to move the fluffing and coating apparatus along the windrow, a fluffing system, a coating system, and an application chamber, said means for simultaneously fluffing and coating the straw performing the sub-steps of:
Step 4A) contacting the straw with a plurality of rapidly rotating fluffing tips and fluffing arms which are attached to a fluffing shaft which is rotated by power supplied by the tractor motivator means;
Step 4B) tossing the straw into the air enclosed within the application chamber; and
Step 4C) applying a coating via the coating system to the straw while the straw is off of the windrow and is in the air.

6. The method of coating straw of claim 5 wherein the drying chamber is a greenhouse that is large enough to enclose a windrow and the tractor motivator means for simultaneously fluffing and coating the straw of claim 5, said greenhouse having a humidistatically operated ventilation system that that opens and pulls moisture out of the greenhouse until the humidity reaches a preset threshold.

7. The method of coating straw of claim 5 wherein step 2 further comprises the steps of:
Step 2A) collecting the straw;
Step 2B) providing a hammer mill straw chopper; and
Step 2C) chopping a quantity of straw to a desired size.

8. The method of coating straw of claim 5 wherein the fluffing and coating apparatus provided in step 4 further comprises the option to disengage the coating function and wherein step 5 further comprises:
Step 5A) operating the fluffing and coating apparatus with the coating function turned off; and
Step 5B) repeating step 5A until the straw is dry.

9. The method of coating straw of claim 6 further comprising the additional steps of:
Step 6) providing a packaging system;
Step 7) placing the coated, dried straw into the packaging system; and
Step 8) packaging the straw for retail sale.

10. The method of coating straw of claim 6 wherein the humidistatically operated ventilation system is an operable window that opens and closes and wherein step 5 further comprises the sub-steps of:
5A) measuring the humidity of the interior of the greenhouse by the humidistatically operated ventilation system;
5B) opening the window when the humidity is above 35 percent; and
5C) closing the window when the humidity reaches a level below 35 percent.

11. The method of coating straw of claim 10 wherein the humdistatically operated ventilation system further comprises a fan to help pull moist air from the greenhouse, said fan also being linked to and controlled by the humidistat.

12. An apparatus for fluffing and coating straw comprising: a motivator means; an apparatus frame removably attached to said motivator means; a fluffing system comprising a rapidly rotating fluffing shaft rotatably attached to said apparatus frame and operably attached to said motivator means; an application chamber; and a coating system comprising a spray tank fixedly attached to said apparatus frame, a plurality of transport lines attached to the application chamber and to said apparatus frame and operably attached to the spray tank, a plurality of spray nozzles operably attached to said transport lines, a hydraulic pump operably connected to the spray tank for distributing the coating through the transport lines to the spray nozzles, and a control means for controlling the flow of the coating through the transport lines and out of the nozzles.

13. The apparatus for fluffing and coating straw of claim 12 wherein the motivator means is a farm tractor having a power take-off and a plurality of hydraulic connector ports.

14. The apparatus for fluffing and coating straw of claim 13 wherein the fluffing shaft is removably and operably connected to the power take-off of the farm tractor, the fluffing shaft runs perpendicular to the tractor, the fluffing shaft rotates at a high rate of revolution necessary to ensure that the straw is rapidly and forcefully projected into the air inside the application chamber and wherein the fluffing system further comprises a plurality of fluffing paddles, a plurality of fluffing arms, and a plurality of fluffing tips, said fluffing paddles being fixedly attached to said fluffing shaft and forming a spiral pattern about said fluffing shaft with the spiral pattern directed inward; said fluffing arms being fixedly attached to said fluffing paddles and radiating outward from the fluffing paddles in a direction away from the fluffing shaft; and said fluffing tips made of a soft material and being removably attached to the end of said fluffing arm.

15. The apparatus for fluffing and coating straw of claim 13 wherein the apparatus frame further comprises a trailer portion and a hood portion, said trailer portion facilitating the removable connection to the farm tractor and comprising a plurality of wheels and a rigid frame for supporting the spray tank and the hydraulic pump of the coating system, said hood portion: being hingedly and hydraulically attached to the trailer portion; operating from an engaged position where the hood portion is lowered and fluffing is taking place to a disengaged position where the hood portion is raised; housing the fluffing system and the application chamber; and comprising a frame for supporting the application chamber, a wheel for contacting the ground when in the engaged position, and a hydraulic cylinder operably connected to the hydraulic ports of the farm tractor for raising and lowering the hood portion from the engaged to disengaged positions.

16. The apparatus for fluffing and coating straw of claim 15 wherein the application chamber is fixedly attached to the hood portion of the apparatus frame and comprises a near wall, a top wall and a far wall each of which provide an inner surface from which the straw can bounce when it is momentarily suspended by the function of the fluffing system.
